(19) United States
(12) Patent Application Publication
(10) Pub. No.: US 2024/0062943 A1
(43) Pub. Date: Feb. 22, 2024

(54) CORE ARRANGEMENT, TRANSFORMER, METHOD FOR PRODUCING A CORE ARRANGEMENT AND METHOD FOR PRODUCING A TRANSFORMER

(71) Applicant: HITACHI ENERGY LTD, Zurich (CH)

(72) Inventors: Roger Eklund, Ludvika (SE); Paolo Pavanello, Granze (PD) (IT); Gianluca Bustreo, Mirano (VE) (IT)

(21) Appl. No.: 18/270,681

(22) PCT Filed: Jan. 14, 2022
(86) PCT No.: PCT/EP2022/050809

§ 371 Date: Jun. 30, 2023

(30) Foreign Application Priority Data
Jan. 15, 2021 (EP) 21151938.4

(51) Int. Cl. H01F 27/245; H01F 41/02

(52) U.S. Cl. CPC H01F 27/245; H01F 41/0233

(57) ABSTRACT

A core arrangement for a transformer is disclosed. The core arrangement comprises a plurality of core sheets. The core sheets have a thickness in the interval of 0.18-0.3 mm. The core sheets are attached to each other by means of an adhesive substance to make the core arrangement self-supporting.

### CROSS REFERENCE TO RELATED APPLICATIONS

This application is a 35 U.S.C. § 371 national stage application of PCT International Application No. PCT/EP2022/050809 filed on Jan. 14, 2022, which in turn claims priority to European Patent Application No. 21151938.4, filed on Jan. 15, 2021, the disclosures and content of which are incorporated by reference herein in their entireties.

### TECHNICAL FIELD

The disclosure relates to the field of power transformers. In particular the disclosure relates to a core arrangement for a transformer.

### BACKGROUND

A power transformer is equipment used in an electric grid of a power system. Power transformers transform voltage and current in order to transport and distribute electric energy. A power transformer comprises at least a primary winding, a secondary winding and a transformer core. The primary and secondary windings are wrapped around both sides of the core. The core may be comprised of thin sheets, also known as laminations, which may be electrically separated by a thin coating of insulating material. The core sheets are usually pressed together with the use of clamping means. One purpose of the core sheets is to reduce certain losses, such as loss in magnetic and electrical energy.

During transformer manufacturing, the core is transported and lifted several times. This means the core is exposed to high mechanical forces during the manufacturing as well as during transport to the customer. To take care of these mechanical forces, the solution today is to design and build a structure around the core to compress the core sheets. The core is strengthened with the help of e.g., support beams, bolts and flitch plates. The movements in the manufacturing should be considered in the design of the clamping structure. Friction, direct force from yoke bolts and the step blocks at a bottom yoke take the mass force.

FIG. 1 illustrates a schematic overview of a core structure 10 for a transformer according to the state of the art. The core structure 10 comprises a core 14, which comprises a plurality of core sheets, and a winding block 11, comprising one or more windings. The core structure 10 also comprises support 17, 18 and press blocks 15, 16 located at the top end and bottom end of the winding block 11. GB 880080 A discloses a core arrangement for a transformer wherein the core arrangement comprises a plurality of core sheets which are attached to each other by means of an adhesive substance.

### SUMMARY

The present disclosure presents an improved viable solution of a core arrangement.

It is an object of embodiments herein to improve the design of a core arrangement, or at least to achieve an alternative to known solutions within the technical field.

According to an aspect the object is achieved by providing a core arrangement for a transformer. The core arrangement comprises a plurality of core sheets. The core sheets are attached to each other by means of an adhesive substance. The thickness of the core sheets is in the interval of 0.18-0.3 millimeters (mm).

According to another aspect the above-mentioned object is also achieved by providing a method for producing a core arrangement. The core arrangement comprises a plurality of core sheets. The core arrangement stacks the core sheets to form a core. An adhesive substance is applied on at least one side of at least one of the core sheets. The core arrangement further cures the stacked core sheets. The thickness of the core sheets is in the interval of 0.18-0.3 mm.

According to another aspect the above-mentioned object is also achieved by providing a method for producing a transformer. The method further comprises producing a core arrangement. A core is moved to an assembly platform. At least one winding block is then mounted to the core. An active part is dried, wherein the active part is the core and the at least one winding block. The active part is then tanked.

It is furthermore provided herein a transformer comprising an embodiment of the core arrangement of the present disclosure.

The current solution is based on the realization that by attaching the core sheets to each other by means of an adhesive substance, a simplified and self-supporting core arrangement is created that is able to further reduce the loss in magnetic and electrical energy.

### BRIEF DESCRIPTION OF THE FIGURES

Further technical features of the disclosure will become apparent through the following description of one or several exemplary embodiments given with reference to the appended figures, where:

FIG. 1 is a schematic overview depicting a core arrangement for a transformer;

FIG. 2 is a schematic overview depicting an exemplifying core arrangement for a transformer, according to some embodiments herein;

FIG. 3 is a schematic overview depicting core sheets forming a core, according to some embodiments herein;

FIG. 4a is a flow chart showing a method for producing a core arrangement, according to some embodiments herein;

FIG. 4b is a flow chart showing a method for producing a transformer, according to some embodiments herein;

FIG. 5 is a schematic overview depicting stacking of core sheets, according to some embodiments herein;

FIG. 6 is a schematic overview depicting a core in an upright position, according to some embodiments herein;

FIG. 7 is a schematic overview depicting an active part assembly area, according to some embodiments herein;

FIG. 8 is a schematic overview depicting another active part assembly area, according to some embodiments herein;

FIG. 9 is a schematic overview depicting another active part, according to some embodiments herein; and

FIG. 10 is a schematic overview depicting an active part without clamping means, according to some embodiments herein.

It should be noted that the drawings have not necessarily been drawn to scale and that the dimensions of certain elements may have been exaggerated for the sake of clarity.

### DETAILED DESCRIPTION

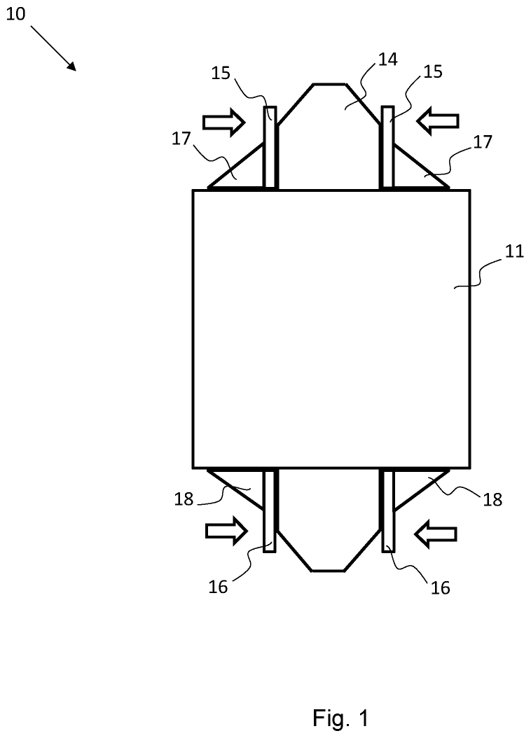

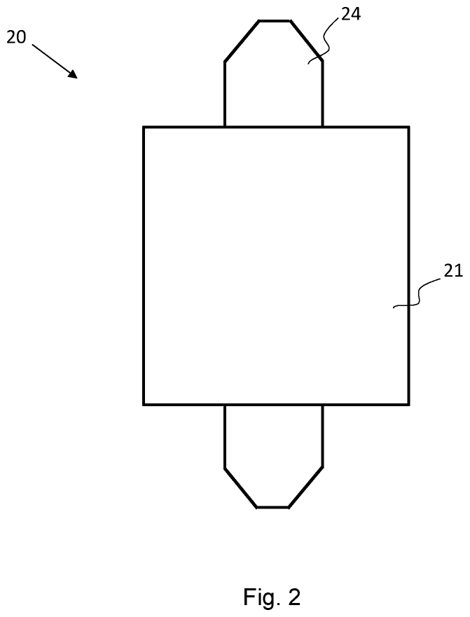

FIG. 2 illustrates a core arrangement 20 for a transformer according to embodiments herein. The core arrangement 20 comprises plurality of core sheets (not shown) forming a core 24. The core arrangement 20 further comprises at least one winding block 21. The winding block 21 comprises one or more windings. As further described in detail in conjunction with the below figures, the core sheets are attached to each other by means of an adhesive substance 26. Thus, by using the adhesive substance 26, e.g., glue, to attach the core sheets together the design of the core arrangement 20 may be simplified and elements such as support 17, 18 and press blocks 15, 16 (shown in FIG. 1) may be replaced with more simple components. The adhesive substance 26 is applied on at least one side of at least one of the core sheets 22. The adhesive substance 26 can be applied during the manufacturing of core sheets, e.g., from suppliers, or can be applied during the production of the core arrangement 20.

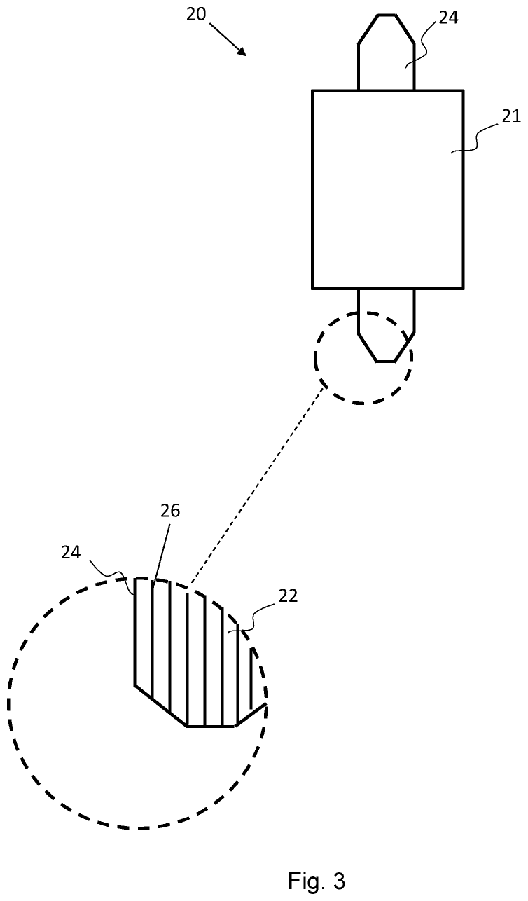

FIG. 3 illustrates a schematic overview according to some embodiments, showing a plurality of core sheets 22 forming the core 24. In some embodiments the core sheets 22 may be in the form of stacked plates or strips. In some embodiments the core sheets 22 may be made of steel. The core sheets 22 may have a thickness in the interval of 0.18-0.3 mm. The core 24, which is formed, e.g., built up, by the core sheets 22, may have a thickness of up to 1800 mm.

According to some embodiments, attaching, e.g., joining, the core sheets 22 together by applying the adhesive substance 26 on at least one side of at least one of the core sheets 22 may make the core arrangement 20 self-supporting.

In some embodiments the adhesive substance 26 may be a bonding varnish or an epoxy coating. The adhesive substance 26 may also be comprised by other suitable substances used for gluing the core sheets 22 together. The adhesive substance 26 may be of insulation property, so that it can replace the actual insulation varnish layer. This is advantageous as it decreases the thickness of the core 24. In some embodiments a curing substance may also be used together with the adhesive substance 26 for attaching the core sheets 22 to each other. The layer of the adhesive substance 26 may have a thickness of approximately up to 10 microns.

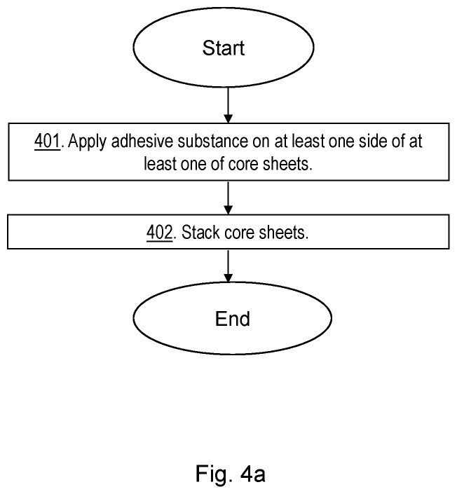

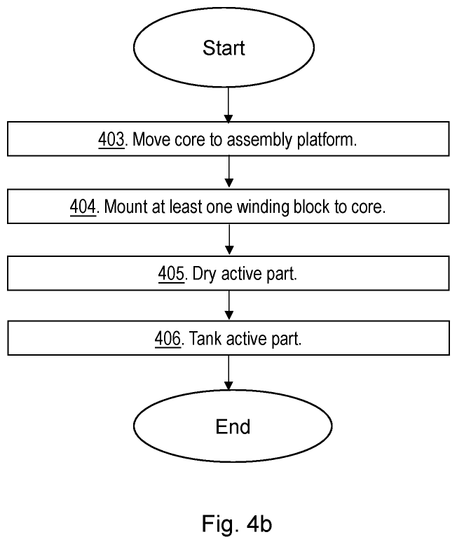

A method for producing the core arrangement 20 according to some embodiments herein may be employed in terms of actions as illustrated by the flow chart in FIG. 4a. The actions do not have to be taken in the order stated below but may be taken in any suitable order. Some optional example embodiments that could be used in this procedure will also be described. The core arrangement 20 comprises a plurality of core sheets 22.

Action 401 comprises stacking the core sheets 22 to form the core 24. The adhesive substance 26 is applied on at least one side of at least one of the core sheets 22. According to some embodiments, the core sheets 22 are attached, e.g., glued, to each other by using bonding varnish. According to some embodiments, the core sheets 22 may be made of steel. In some embodiments a curing substance may also be used together with the adhesive substance 26 for attaching the core sheets 22 to each other.

Action 402 comprises curing the stacked core sheets 22. According to some embodiments the adhesive substance 26 may be cured directly after the core stacking before the core 24 is lifted and moved, e.g., transported. According to some embodiments the adhesive substance 26 may be cured in a drying process of the active part.

A method for producing the transformer according to some embodiments herein may be employed in terms of actions as illustrated by the flow chart in FIG. 4b. The actions do not have to be taken in the order stated below but may be taken in any suitable order. Some optional example embodiments that could be used in this procedure will also be described.

Action 403 comprises moving the core 24 to an assembly platform.

Action 404 comprises mounting the at least one winding block 21 to the core 24.

Action 405 comprises drying an active part, wherein the active part is the core 24 and the at least one winding block 21. The temporary clamping means are removed.

According to some embodiments the temporary clamping means may be removed before or after the tanking. According to some embodiments the attached core sheets may be delivered already from supplier and cured, e.g., dried, during the production. According to some embodiments the adhesive substance 26 may be cured in the ordinary drying process of the active part.

Action 407 comprises tanking the active part. Tanking the active part means mounting of the active part in a transformer tank.

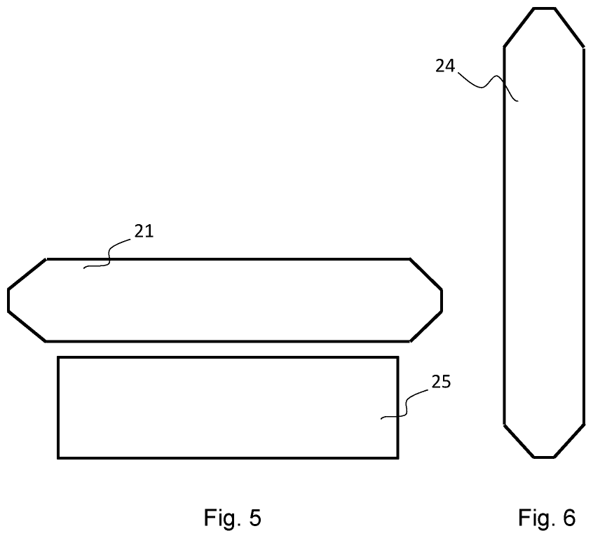

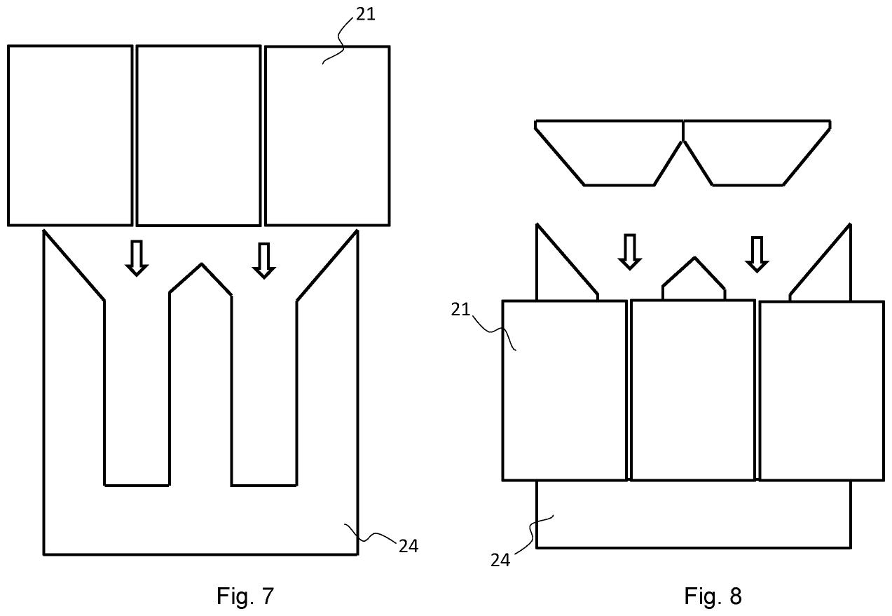

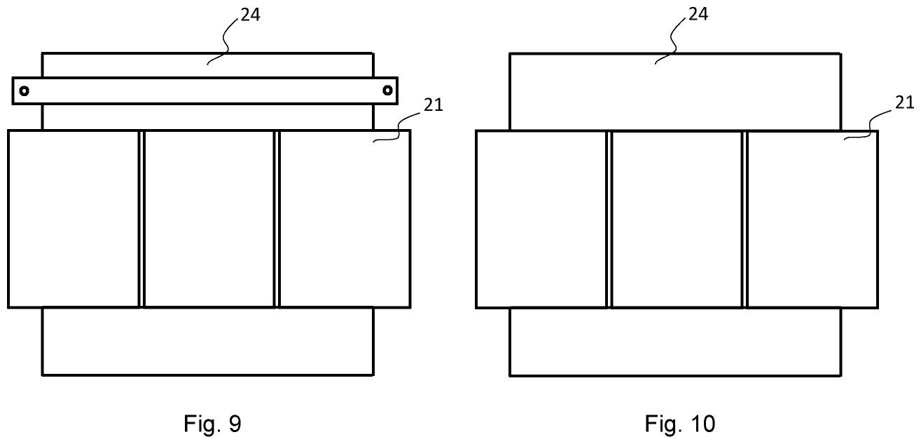

In the above-described methods for producing the core arrangement 20 and the transformer according to embodiments herein, the adhesive substance 26 may be applied on at least one side of each of the core sheets 22. As shown in FIG. 5, the core sheets are then stacked, e.g., on a core-stacking table 25 such as E-stacker, to form the core 24. After stacking the core sheets 22, the core 24 may be clamped and raised to an upright, e.g., vertical, position, as illustrated in FIG. 6. Optionally the core 24 may be heated before it is raised. The core 24 may be clamped by use of temporary clamping means which later will be removed. The core 24 may then be moved, e.g., transported by an overhead crane, to an active part assembly area. In some factories, part of the transportation may be performed by air cushions. At an active part assembly area, the core 24 may be equipped with windings, top yoke, cleats and leads, as depicted in FIG. 7 and FIG. 8. The active part of the transformer mainly comprises the elements that are in contact with the voltage and the current, e.g., the at least one winding block 21 and the core 24. FIG. 9 and FIG. 10 shows that the active part, i.e., the core 24 and the at least one winding block 21, may then be dried in an oven, e.g., a Vapour Phase (VP)-oven, retightened and tanked, which also involves several lifting operations. The adhesive substance 26 may be hardened, e.g., cured, in the drying process of the active part.

An advantage with embodiments herein is that parts related to the core can be removed. This means that there are less parts to mount which in turn leads to savings in labour, core building and in the active part.

A further advantage of embodiments herein is that the loss in magnetic and electrical energy may be further reduced.

Another advantage of embodiments herein that noise may be reduced, as there is a reduction of vibrations of the core sheets.

The adhesive substance 26 may be of insulation property and can replace the actual insulation varnish layer. This is advantageous as it decreases the thickness of the core 24.

Consequently, a core arrangement that is simplified and self-supporting and that is able to further reduce the loss in magnetic and electrical energy is achieved.

It is to be noted that any feature of any of the aspects may be applied to any other aspect, wherever appropriate. Likewise, any advantage of any of the aspects may apply to any of the other aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

It will be appreciated that the foregoing description and the accompanying drawings represent non-limiting examples of the method and winding arrangement taught herein. As such, the winding arrangement and techniques taught herein are not limited by the foregoing description and accompanying drawings. Instead, the embodiments herein are limited only by the following claims and their legal equivalents.

1. A core arrangement for a transformer, wherein the core arrangement comprises a plurality of core sheets, and wherein the core sheets are attached to each other by means of an adhesive substance, and wherein the core sheets have a thickness in the interval of 0.18-0.3 mm.

2. The core arrangement according to claim 1, wherein the attached core sheets make the core arrangement self-supporting.

3. The core arrangement according to claim 1, wherein said core sheets are in the form of stacked plates or strips.

4. The core arrangement according to claim 1, wherein the core sheets are made of steel.

5. The core arrangement according to claim 1, wherein the adhesive substance is any one out of at least one of a bonding varnish or an epoxy coating.

6. The core arrangement according to claim 1, wherein the adhesive substance is applied on at least one side of at least one of the core sheets.

7. The core arrangement according to claim 1, wherein the core sheets are attached to each other by means of the adhesive substance and a curing substance.

8. A transformer comprising the core arrangement according to claim 1.

9. A method for producing a core arrangement for a transformer, wherein the core arrangement comprises a plurality of core sheets, the method comprising:
stacking the core sheets to form a core, wherein an adhesive substance is applied on at least one side of at least one of the core sheets; and
curing the stacked core sheets, and wherein the core sheets have a thickness in the interval of 0.18-0.3 mm.

10. The method according to claim 9, wherein the attached core sheets make the core arrangement self-supporting.

11. The method according to claim 9, wherein said core sheets are in the form of stacked plates or strips.

12. The method according to claim 9, wherein the core sheets are made of steel.

13. The method according to claim 9, wherein the adhesive substance is at least one of a bonding varnish or an epoxy coating.

14. The method according to claim 9, wherein the applying the adhesive substance on at least one side of at least one of the core sheets comprises applying the adhesive substance and a curing substance on at least one side of at least one of the core sheets.

15. A method for producing a transformer, said method comprising producing a core arrangement according to claim 9, wherein the method comprises:
moving a core to an assembly platform;
mounting at least one winding block to the core;
drying an active part, wherein the active part is the core and the at least one winding block; and
tanking the active part.

16. The method according to claim 15, further comprises removing temporary clamping means before or after the tanking.

17. The method according to claim 15, wherein tanking the active part comprises mounting of the active part in a transformer tank.

18. The method according to claim 15, wherein drying the active part comprises curing an adhesive substance that is applied to one or more core sheets of the core.

19. The method according to claim 1, wherein the adhesive substance includes an insulation property.

20. The method according to claim 9, wherein the adhesive substance includes an insulation property.
